(19) United States
(12) Patent Application Publication
(10) Pub. No.: US 2004/0050564 A1
(43) Pub. Date: Mar. 18, 2004

(54) Box scraper assembly with self-guiding hitch system for attachment to tractor implements

(76) Inventor: Stanley D. Wilson, Hartford, IN (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/632,312

(22) Filed: Jul. 30, 2003

Related U.S. Application Data
(60) Provisional application No. 60/399,374, filed on Jul. 30, 2002.

(51) Int. Cl. A01B 31/00

(52) U.S. Cl. 172/684.5

(57) ABSTRACT

A combination box scraper assembly compatible with a tractor's three-point hitch and includes a self-guiding hitch system which enables the connection of a variety of tractor implements to the box scraper. The box scraper includes a hydraulically operated tool attachment, and a rake member that is manually raised and lowered with a lever. A horizontal support member is fixedly disposed between the sides of the box scraper. First and second arms are attached to the support member and upwardly extend from the support member and converge to form a bracket member for attachment to the tractor's three-point hitch. The lower ends of the arms are spaced apart for attachment to the tractor's hitch system. First and second plates are attached to the support member parallel to the first and second arms. The first and second plates each have an extension member that downwardly depends from the plates. Each of the extension members include an extension aperture for connecting the box scraper to the tractor implement. Each of the extension members further include an angled stop block attached to the outer surface of the members. The tractor implement includes a brace member and a pair of brackets attached to the brace member and spaced to receive and connect the extension members of the box scraper to the implement with connecting pins.

### CROSS REFERENCES TO RELATED APPLICATIONS

U.S. Provisional Application for Patent No. 60/399,374, filed Jul. 30, 2002, with title, “Combination Box Scraper With Self Guiding Hitch System” which is hereby incorporated by reference. Applicant claims priority pursuant to 35 U.S.C. Para. 119(e)(i).

Statement as to rights to inventions made under Federally sponsored research and development: Not Applicable

### BACKGROUND OF THE INVENTION

1. Field of the Invention

The present invention relates generally to a box scraper assembly for attachment to the rear of a farm tractor, construction equipment and various earth moving equipment and more particularly, the present invention is directed to a combination box scraper assembly that includes a self-guiding hitch system for connection with a variety of tractor implements. 2. Brief Description of Prior Art.

Tractors are customarily used with a variety of implements to perform the many functions for which tractors are utilized for farming, mowing, landscaping, construction, or the like. The size of a tractor determines the range of tractor functions, however, all tractors are equipped for use with implements. Commonly used tractor implements include the plow, rotary tiller, aerator, mower, seeder, straw crimper, or other implements, for farming, construction and landscaping. The tractor is also commonly used to drag, push or otherwise move a heavy tool called a box scraper. The box scraper is intended to encounter material such as earth or stone, in small hills or heaps, and to distribute the material along the path to achieve an approximately level topography. A box scraper is often used to flatten or alter an undesirable slope.

Numerous box scrapers are known in the art, and are used for many purposes including landscaping, grading, leveling, road building, snow removal, and numerous other material handling purposes. A box scraper is a heavy and durable steel tool, and is usually of the form of a rectangular box which is open at the top and bottom. The scraper blade meets the ground at an angle which can be altered by a hydraulic control system of the tractor.

In the past a user would typically be faced with a variety of tasks relative to spreading, grading and hauling. To efficiently and effectively do these jobs especially for big projects, it was necessary to have a variety of different tractor implements or pieces of equipment on hand. Each piece of equipment would be used on a different task as, for example, for grading around a dwelling, grading along side a highway, grading different types of materials to different depths, aerating, and seeding. It further was often found necessary to switch back and forth between one implement and the next thereby wasting very valuable time in the switch. Thus, a strong need has existed for an assembly which can be easily adapted for a variety of different uses, and which further is easily adapted in the field to these uses with a limited number of tools.

As will be seen from the subsequent description, the preferred embodiments of the present invention overcome the above problems and difficulties of the prior art.

### SUMMARY OF THE INVENTION

The present invention is directed to a combination box scraper assembly that is compatible with a three-point tractor implement hitch and further includes a self-guiding hitch system which enables the connection of a variety of modified tractor implements to the box scraper. As such, the present invention can be easily adapted for a variety of different uses and avoids the waste of time of switching needed implements during application. The box scraper assembly of the present invention is mounted for towing behind a tractor. Box scraper is roughly a box, having opposed end sides, a front side, and a back side. The box scraper includes a hydraulically operated tool attachment that includes a first tool member and a second tool member. The tool attachment may be positioned so that either the first tool member, the second member, or both members are in contact with the ground. The box scraper further includes a rake member that is manually raised and lowered with a lever. The rake member is hingedly mounted to a horizontal support member disposed between the inner surfaces of the end sides. A pair of upwardly extending first and second arms are attached to the support member. The arms upwardly extend from the support member and the distal ends of the arms form a bracket member for attachment to the tractor's three-point hitch. A first plate is attached to the support member parallel to the first arm's lower end, and a second plate is attached to the support member parallel to the second arm's lower end. The first and second plates each include an aperture in alignment with apertures of the lower ends of the arms for receipt of connecting pins. The lower end of the first arm and the first plate form a bracket member for attachment to the tractor's three-point hitch. Likewise, the lower end of the second arm and the second plate form a bracket member for attachment to the tractor's three-point hitch. The first and second plates each include an extension member that downwardly depends from the plates. The extension members each include an angled stop block attached to the outer surface of the members with welds, that assist the operator in aligning the box scraper with the tractor implement for attachment. The tractor implement includes a horizontal brace member having a pair of brackets to receive the extension members of the box scraper for connection with the connection pin. A pair of angled guide plates are attached at an angle to the brackets of the tractor implement. The guide plates assist the operator in attaching the implement to the box scraper by guiding the extension members of the box scraper into the brackets of the implement for connection.

### BRIEF DESCRIPTION OF THE DRAWINGS

FIG. 1 a perspective view of a preferred embodiment of the present invention, a box scraper assembly with self-guiding hitch system attached to a straw crimper implement.

FIG. 2 is a perspective view of the box scraper of FIG. 1 without the straw crimper implement.

FIG. 3 is a perspective view of the straw crimper implement of FIG. 1.

FIG. 4 is a side view of the box scraper assembly of FIG. 2 with a tool attachment not in use, and further illustrating a rake member engaged.

FIG. 5 is a side view of the box scraper assembly of FIG. 1.

FIG. 6 is a side view of the box scraper implement of FIG. 2 with a first tool member of the tool attachment in use.

FIG. 7 is a side view of the box scraper assembly of FIG. 2 with the first tool member and a second tool member of the tool attachment in use.

### DESCRIPTION OF THE PREFERRED EMBODIMENT

In accordance with the present invention, a box scraper assembly with self-guiding hitch system is disclosed. The box scraper assembly is directed to an apparatus that can be adapted for performing a variety of tasks relative to farming, landscaping, construction, or the like, and is easily adapted in the field to these uses with a limited number of tools. Specifically, it will be noted in the drawings that the combination box scraper assembly includes a self-guiding hitch system that enables the connection of a variety of tractor implements that perform a variety of functions. In the broadest context, the combination box scraper of the present invention consists of components configured and correlated with respect to each other so as to attain the desired objectives.

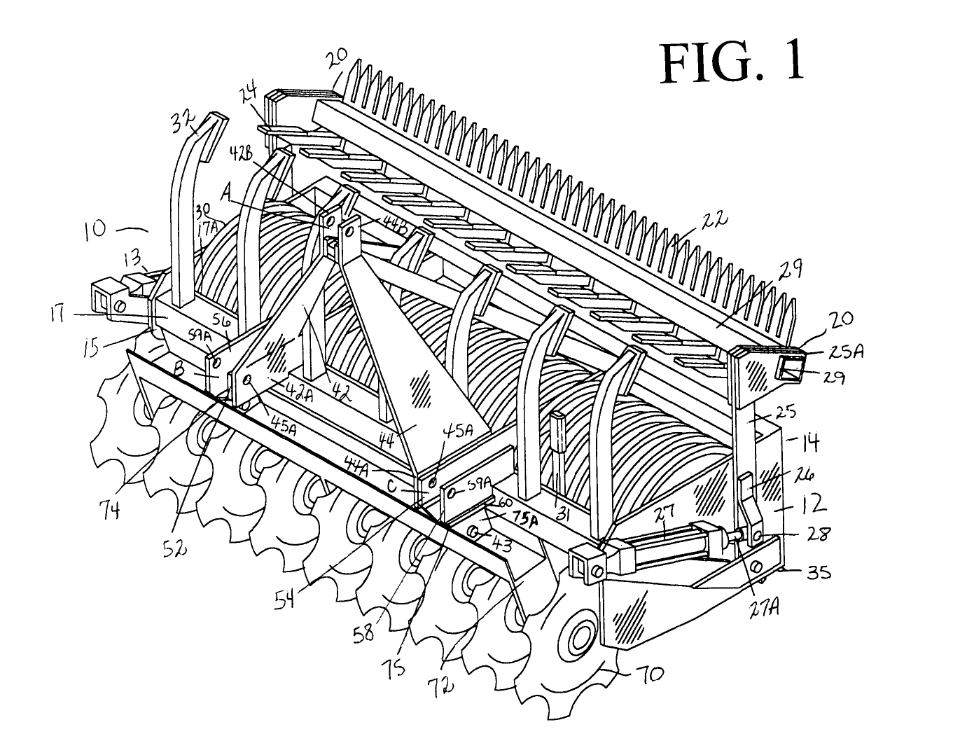

FIGS. 1-7 illustrate embodiments of a combination box scraper apparatus 10 made in accordance of the present invention. The apparatus 10 is mounted for towing behind a tractor (not shown). Box scraper 10 is roughly a box, having opposed end sides 12, 13, a front side 14, and a back side 15. The tractor as is well known in the art, is also provided with a suitable hydraulic system for raising, lowering and tilting the box scraper 10.

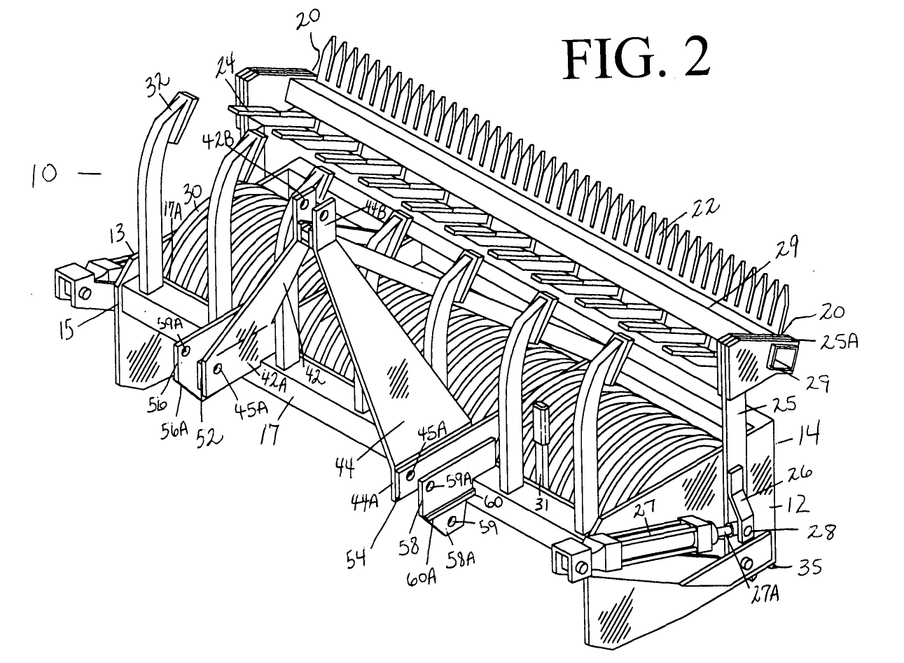

The box scraper 10 as best shown in FIGS. 1 and 2 includes a hydraulically operated tool attachment 20. For purposes of example, the drawings display the tool attachment 20 as being a combination scarifying/comb attachment that generally includes a comb member 22 and a scarifying member 24, however other tool implements 22, 24 may be used.

As shown in the drawings, the tool attachment 20 extends from the sides 12, 13 of the box scraper 10. Preferably, a hydraulic lift 27 is attached at one end to each side 12, 13 of the box scraper 10 with a hydraulic ram 27A of the lift 27 pivotally attached to a vertical arm 25 of the tool attachment 20 with a pivot member 26 and connector pin 28. The hydraulic lines while not shown in the drawings can be driven by the hydraulic system of the tractor.

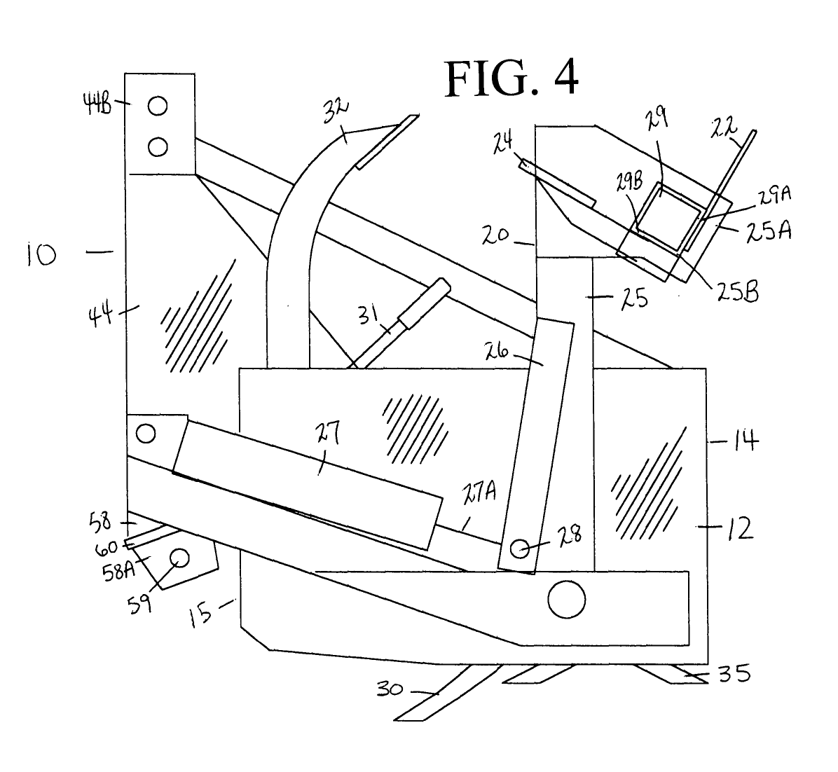

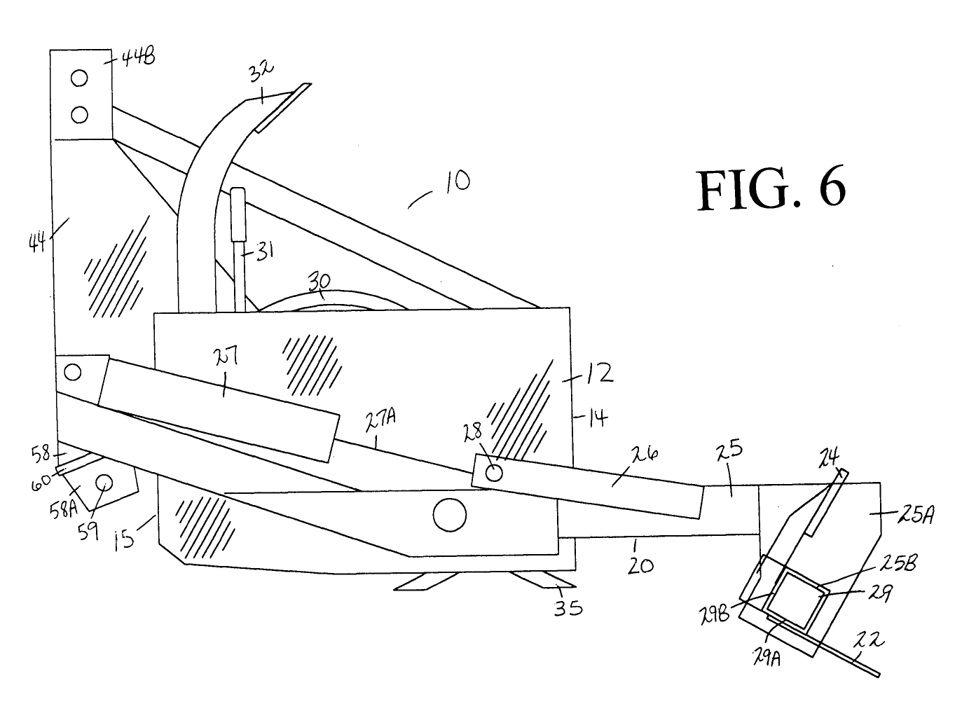

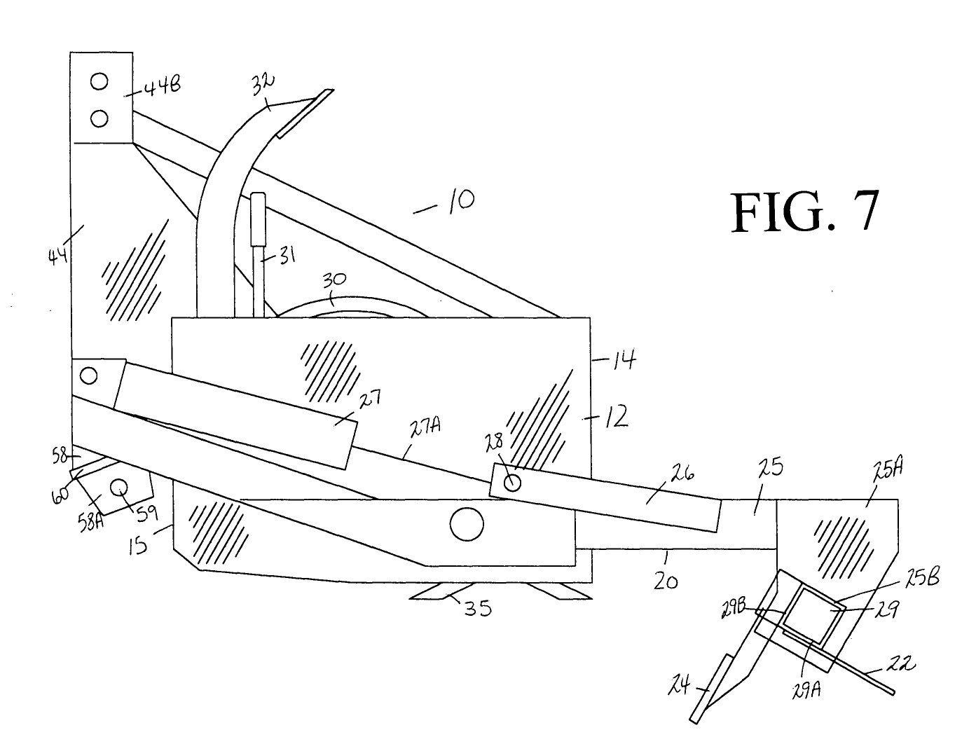

The distal end of each of the vertical arms 25 is attached to a horizontal bar 29 that horizontally extends the approximate length of the box scraper 10. In the preferred embodiment, the arm 25 is attached an arm bracket 25A that includes an aperture 25B therethrough sized and shaped to receive the horizontal bar 29. The tool member 22 is attached to a first side 29A of the bar 29, and the tool member 24 is attached to a second side 29B, as shown in FIGS. 4-7. As will be further described, in application, the tool attachment 20 may be pivotally positioned so that either the comb member 22 (as shown in FIG. 6), or the scarifying member 24, or both members 22, 24 (as shown in FIG. 7) are in contact with the ground.

The operator may position the arm 25 to extend substantially vertical in a first position when the tool attachment 20 is not in use as shown in FIGS. 1, 2, 4 and 5, or may be positioned substantially horizontal in a second position as shown in FIGS. 6 and 7 when the attachment 20 is in use. The tool attachment 20 is pivotally disposed to the first or second position by positioning the pivot member 26 using the hydraulic lifts 27 as is known in the art. It should be understood that in application, the tool attachment 20 may be positioned in the second position so that only the scarifying member 24 for example, is in use. In this position, the box scraper 10 may also be positioned to grade the ground. As such, the box scraper 10 and the tool attachment 20 may be positioned by the operator to function separately, or at the same time. As is understood, the selective depth of the tool attachment 20 to the ground may control the cutting depth of the blade of the box scraper 10.

The box scraper 10 further includes a rake member 30 that is manually raised and lowered with a lever 31. The rake member 30 is pivotally disposed between the inner surfaces of the end sides 12 and 13, and attached to a back surface 17A of a horizontal support member 17 with hinges (not shown). The rake member 30 is preferably attached to a horizontal rod (not shown) that is appropriately connected to the lever 31 and disposed between the hinges and the back surface 17A of the horizontal support member 17. The horizontal rod extends between the end sides 12, 13 and is parallel with the support member 17. In application, the lever 31 pivotally engages or disengages the rake member 30 on the horizontal rod. Such pivoting means is known in the art. The box scraper 10, as is known in the art, further includes a cutter blade 35 disposed on the lower surface of the box scraper 10, and scarifying teeth 32.

The conventional tractor is equipped with a three-point implement hitch (now shown) for operative attachment to one of the several implements commonly employed with such general application tractors. The three-point hitch generally including three lift arms that extend from the rear of the tractor. The box scraper 10 is constructed for attachment to the conventional three-point hitch provided on the tractor at those connection locations designated in FIG. 1 as “A”, “B”, and “C”. In particular, the box scraper 10 is constructed so that each of the tractor's three lift arms of the three-point hitch attach to the box scraper 10 at the locations designated “A”, “B,” and “C”. The three-point hitch of the tractor is typically equipped for hydraulic positioning and manipulation of the implement with hydraulic means known in the art. The attachment of the box scraper 10 of the present invention to the three-point hitch does not effect the operation of the three-point hitch as described, and the method of attaching the box scraper 10 is conventional and known in the art.

As shown in the drawings, the locations designated on the box scraper 10 for connecting with the tractor's three-point hitch (locations “A”, “B”, and “C”) is disposed generally on the back side 15 of the box scraper 10. A pair of upwardly extending arms 42 and 44 are attached to the support member 17 at lower ends 42A and 44A with welds. The arms 42 upwardly extend from the support member 17 and the arms distal ends 42B and 44B substantially converge to form the area designated “A”. As should be understood, the spacing between the ends 42B and 44B are sized to receive one of the lift arms of the tractor's conventional three-point hitch. Likewise, the lower ends 42A, 44A of the arms 42, 44 are spaced apart similar to the spacing of the lift arms of the three-point hitch in order to each receive one of the lift arms as will be discussed.

Gussets 52 and 54 are each attached to the outer surface of the arms 42, 44 lower ends 42A and 44A respectively. As shown in the drawings, the gussets 52, 54 and the lower ends 42A, 44A of the arms 42, 44 each having an upper aperture 45A in alignment for receipt of connecting pins (not shown) when attaching the box scrapper 10 to the tractor's hitch system. A first plate 56 is attached to the support member 17 and positioned generally parallel to gusset 52. A second plate 58 is attached to the support member 17 and positioned generally parallel to gusset 54. The plates 56, 58 each include an aperture 59A in alignment with the apertures 45A of the arms' lower ends 42A, 44A and gussets 52, 54 for receipt of the connecting pin.

The gusset 52 affixed to the arm 42, and the first plate 56 form the location designated as “B” for receipt of one of the lift arms of the tractor's three-point hitch. As should be understood, the spacing between the gusset 52 and the plate 56 is sized to receive one of the lift arms of the tractor's three-point hitch. Likewise, the gusset 54 attached to the arm 44, and the second plate 58 form the location designated as “C” for receipt of the lift arm of the tractor's three-point hitch. As should be understood, the spacing between the gusset 54 and the plate 58 is sized to receive one of the lift arms. The gussets 52, 54 provide a support brace for stabilizing the arms 42, 44 of the box scraper 10 as the tractor tows the box scraper 10. The removable connector pins is received within the apertures 45A, 59A for releasably affixing the tractor's three-point hitch to the box scraper 10.

As best shown in FIG. 2, the first and second plates 56, 58 each include an extension member 56A and 58A, respectively. The extension members 56A, 58A downwardly depend from the plates 56, 58 and are positioned substantially parallel to one another. Each of the extension members 56A, 58A include an extension aperture 59 for connecting with the variety of tractor implements as will be further discussed.

The extension members 56A, 58A each further include a stop block 60 attached to the outer surface of the members 56A, 58A with welds. The blocks 60 is attached to each of the members 56A, 58A as described above at an angle so that the block 60 is disposed in a downwardly direction from the back side 15 of the box scraper 10. As will be further discussed, the angled stop blocks 60 assist the operator in aligning the box scraper 10 with the tractor implement for attachment.

FIGS. 1, 3, and 5 show an implement 70 of the present invention attached to the box scraper 10. The implement 70 having a brace member 72 that horizontally extends the length of the implement 70. As shown in the drawings, first and second brackets 74, 75 are attached to the brace member 72 with welds. The brackets 74, 75 are spaced apart so that the bracket 74 may receive the extension member 56A of the plate 56, and the bracket 75 is likewise sized to receive the extension member 58A of the plate 58.

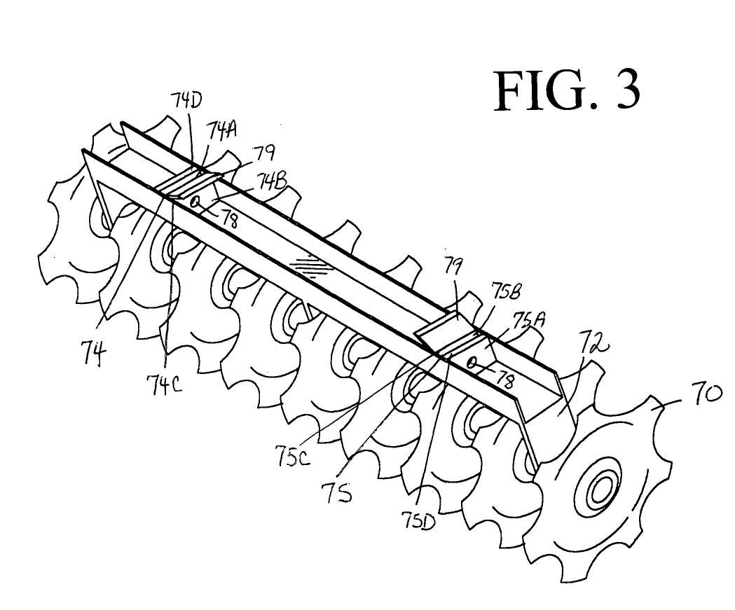

Referring to FIG. 3, the bracket 74 is formed of outer and inner implement plates 74A, 74B, and the bracket 75 is likewise formed of outer and inner implement plates 75A, 75B. Each of the plates 74A, 74B, and 75A, 75B having aligned apertures 78.

The present invention further includes at least one angled guide plate 79 attached to either one or both of the inner implement plates 74B, 75B with welds. In particular, guide plate 79 is attached at an angle to the upper ends 74C, 75C of the inner implement plates 74B, 75B. When attached, the guide plates 79 converge in an inwardly direction as shown in FIG. 3.

The unique features of the box scraper 10 described above makes it extremely versatile and capable of attaching to multiple tractor implements that carry out a multiplicity of functions which heretofore required separate devices or implements specially designated for a specific function, this versatility being best illustrated in FIG. 1.

In FIG. 1, the box scraper 10 is shown ready for mounting on the three-point hitch of the tractor with the back side 15 facing in the direction of the rear of the tractor. In this configuration, the box scraper 10 is pulled behind the tractor.

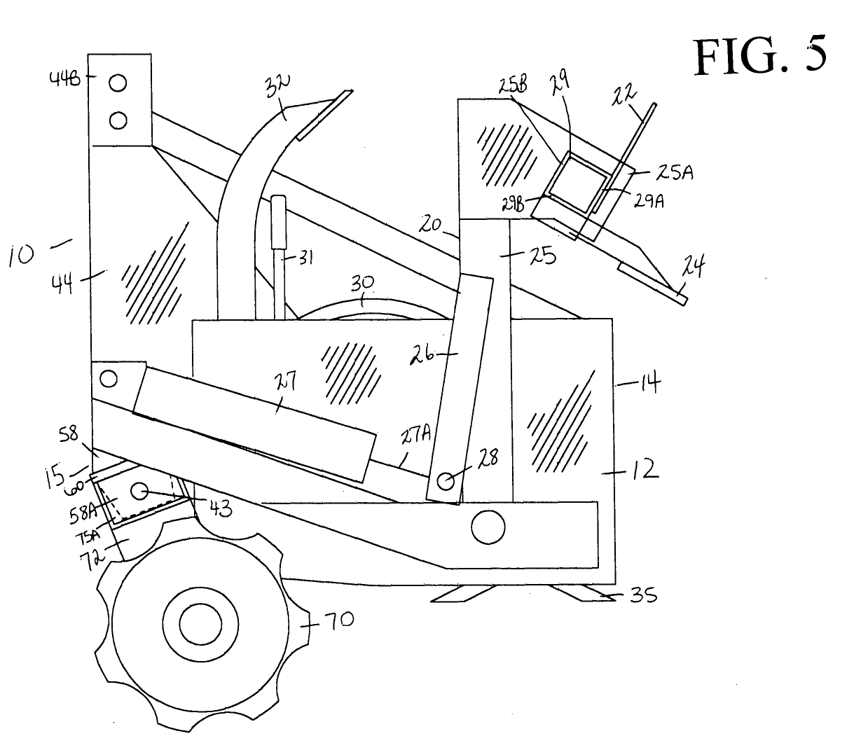

To attach the straw crimper implement 70, the operator of the tractor raises the three-point hitch in the conventional manner, whereupon the box scraper 10 is moved upwardly. Further upward movement of the three-point hitch raises the box scraper 10 completely off the ground. As stated, this is the conventional method for transporting the implement to any desired location by the tractor. The box scraper 10 is then elevated a distance above the ground sufficient to permit the cutter blade 35 of the box scraper 10 to be at a height above the ground which is greater than the height of the brackets 74, 75 of the implement to be attached, in this case, the straw crimper implement 70. The tractor carrying the box scraper 10 is then backed up to position extension members 56A, 58A directly above the brackets 74, 75 of the straw crimper implement 70. The box scraper 10 is then lowered such that the extension members 56A, 58A are received within the brackets 74, 75, respectively. In particular, the box scraper 10 is lowered so that the extension member 56A is received between the plates 74A, 74B of the bracket 74, for attachment as described above, and the extension member 58A is received within the plates 75A, 75B of the bracket 75. Once the apertures 78 of the implement plates 74A, 74B, and 75A, 75B are in alignment with the extension apertures 59 of each of the extension members 56A, 58A as described above, connector pins 43 (shown in FIGS. 1 and 5) are inserted within the apertures to attach the implement 70 to the box scraper 10.

When lowering the box scraper 10 as described above, the extension members 56A and/or 58A may be lowered to first rest on one or both of the angled guide plates 79 of the inner implement plates 74B, 75B. Further lowering of the box scraper 10 causes the extension member 56A and/or 58A to slide down the guide plate 79 and into the brackets 74, 75 of the implement 70. As such, the guide plates 79 serve to assist the operator in attaching the implement by guiding the extension member of the box scraper 10 into the brackets of the implement for connection.

The angled stop block 60 further assists the operator in aligning the extension member with the brackets of the implement for attachment as described above. When lowering the box scraper 10 as described above, a lower edge 60A (shown in 60A) of the stop block 60 may come in contact with an upper edge 74D (shown in FIG. 3) of the outer implement plate 74A, and/or an upper edge 75D of the plate 75A. Further lowering of the box scraper 10 causes the lower edge 60A of the stop block 60 to downwardly slide along the upper edge 74D, 75D of the outer implement plates 74A, 75A until the extension members 56A, 58A are positioned within the brackets 74, 75. As such, the angled stop block 60 further assists the operator in attaching the implement by guiding the extension members of the box scraper into the brackets of the tractor implement for connection.

The ability to raise and lower the box scraper 10 in the manner indicated above is well known to those of ordinary skill in the art, and is accomplished with any of a variety of height control apparatus operatively associated with the tractor carrying the box scraper 10.

It is thus a simple procedure for assembling and disassembling the present apparatus. The three-point hitch is first attached to the box scraper 10 by using hitch pins and a suitable bolt tightly fastened at the three connections “A”, “B”, and “C”. The box scraper 10 is then ready for use or may be raised and positioned over the additional implement for attachment to the box scraper 10 as described above. It is thus seen that it is a rather simple procedure to convert the assembly between its box scraper mode and the mode of the attached additional implement. It further is very easy to assemble and disassemble the convertible assembly.

It is intended that all components of the apparatus be fabricated of heavy, substantial steel stock for strength and durability, or be fabricated of any other appropriate material.

While in the specification and in the drawings, a general conception of a combination box scraper with self-guiding hitch system has been described, it should be understood that various modifications can be accomplished using merely routine engineering practices, without rising to the level of invention and without departure from true spirit and scope of this invention.

Thus the scope of the invention should be determined by the claims in the formal application and their legal equivalents, rather than by the examples given.

I claim:

1. A combination box scraper assembly for attaching to a three-point hitch at the rear of a tractor, the assembly further includes a self-guiding hitch system which enables the connection of a variety of tractor implements, the box scraper assembly comprising:
a frame having two spaced opposing end sides, and a back side extending between the end sides,
a scarifying/comb attachment having at least one arm, said arm having a first end and a second end opposite the first end, wherein a comb bracket is attached to the second end of the arm, said comb bracket including an aperture,
a hydraulic lift having a hydraulic ram, wherein an end of the hydraulic lift opposite the hydraulic ram is attached to the frame, and the hydraulic ram is pivotally attached to the first end of the arm of the scarifying/comb attachment,
a horizontal bar disposed within the aperture of the bracket,
a scarifying member attached to a first side of the horizontal bar, and a comb member attached to a second side of the horizontal bar,
a rake member positioned forward of said back side between the end sides of the box scraper, said rake member attached to a horizontal support member,
pivot means attached to the rake member for pivoting the rake member, and
attachment means secured to the horizontal support member for releasably attaching the box scraper to the three-point hitch.

2. The box scraper assembly as recited in claim 1, wherein ends of said rake member is mounted to the horizontal support member with hinges, said rake member is further attached to a horizontal rod disposed between the hinges and the horizontal support member, said horizontal rod disposed between the end sides of the box scraper and parallel with the horizontal support member.

3. The box scraper assembly as recited in claim 3, wherein the rake member includes a lever attached to the horizontal rod for selectively engaging and disengaging the rake member.

4. The box scraper assembly as recited in claim 1, wherein the at least one arm of the scarifying/comb attachment is hydraulically positioned in a first position when the attachment is not in use, and a second position when the attachment is in use.

5. The box scraper assembly as recited in claim 1, further including a self-guiding hitch disposed on the back side of the box scraper, said self-guiding hitch comprising:
a pair of upwardly extending arms having upper and lower ends, wherein the lower ends are attached to the support member of the box scraper, and the upper ends upwardly extend from the support member forming an upper bracket for connecting with the tractor's three-point hitch,
a pair of extension members that downwardly depend from the support member, wherein each of the extension members include an extension aperture, and a stop block attached at an angle to the outer surface of the extension members.

6. The box scraper assembly as recited in claim 1, wherein the tractor implement comprising:
a horizontal brace member,
first and second brackets attached to the brace member, said first and second brackets each including an inner plate and an outer plate, said inner and outer plates of the first and second brackets having aligned bracket apertures,
a first guide plate attached at an angle to an upper end of the inner plate of the first bracket, and a second guide plate attached at an angle to an upper end of the inner plate of the second bracket,
wherein said guide plates are angled inwardly,
wherein said first and second brackets sized to releasably receive the extension members of the box scraper, and
attachment means for releasably attaching the box scraper to a tractor implement.

7. The box scraper assembly as recited in claim 6, further including connecting pins for connecting the extension members to the first and second brackets of the implement.

8. A combination box scraper assembly for attaching to a three-point hitch at the rear of a tractor, the assembly further includes a self-guiding hitch system which enables the connection of a variety of tractor implements, the box scraper assembly comprising:
a frame having two spaced opposing end sides, and a back side extending between the end sides,
a tool attachment having at least one arm, said arm having a first end and a second end opposite the first end,
a hydraulic lift having a hydraulic ram, wherein one end of the hydraulic lift is attached to the frame, and the hydraulic ram opposite the one end is pivotally attached to the first end of the arm of the tool attachment,
a horizontal bar attached to the second end of the arm,
at least one first tool member attached to a side of the horizontal bar,
a rake member positioned forward of said back side between the end sides of the box scraper, said rake member attached to a horizontal support member,
pivot means attached to the rake member for pivoting the rake member.

9. The box scraper assembly as recited in claim 8, wherein ends of said rake member is mounted to the horizontal support member with hinges, said rake member is further attached to a horizontal rod disposed between the hinges and the horizontal support member, said horizontal rod disposed between the end sides of the box scraper and parallel with the horizontal support member.

10. The box scraper assembly as recited in claim 9, wherein the rake member includes a lever attached to the horizontal rod for selectively engaging and disengaging the rake member.

11. The box scraper assembly as recited in claim 8, wherein the at least one arm of the tool attachment is hydraulically positioned in a first position when the attachment is not in use, and a second position when the attachment is in use.

12. The box scraper assembly as recited in claim 8, further including a self-guiding hitch disposed on the back side of the box scraper for connecting with the tractor implement, said self-guiding hitch comprising:
first and second upwardly extending arms having upper and lower ends, wherein the lower ends are attached to the support member of the box scraper, and the upper ends upwardly extend from the support member forming an upper bracket for connecting with the tractor's three-point hitch,
a first scraper bracket formed of the lower end of the first extending arm and a first plate attached to the support member parallel with the lower end of the first extending arm, and a second scraper bracket formed of the lower end of the second extending arm and a second plate attached to the support member parallel with the lower end of the second extending arm,
a first attachment means for releasably attaching the tractor's three-point hitch to the first and second scraper brackets,
a first extension member that downwardly depends from the first plate, and a second extension member that downwardly depends from the second plate, wherein each of the extension members include an extension aperture, and
a stop block attached at an angle to the outer surface of the extension members.

13. The box scraper assembly as recited in claim 8, further including a tractor implement comprising:
a horizontal brace member,
first and second implement brackets attached to the brace member, said first and second implement brackets each formed of an inner plate and an outer plate, said inner and outer plates of the first and second implement brackets having aligned bracket apertures,
a first guide plate attached at an angle to an upper end of the inner plate of the first implement bracket, and a second guide plate attached at an angle to an upper end of the inner plate of the second implement bracket,
wherein said first and second implement brackets sized to releasably receive the first and second extension members of the box scraper.

14. The box scraper assembly as recited in claim 13, wherein the tractor implement further includes a second attachment means for releasably attaching the first and second extension members of the box scraper to the first and second implement brackets of the tractor implement.

15. The box scraper assembly as recited in claim 14, wherein the second attachment means is connecting pins.

16. The box scraper assembly as recited in claim 13, wherein the first and second guide plates are angled inwardly.

17. A method for connecting a box scraper assembly with self-guiding hitch system to a tractor implement, the assembly further includes a self-guiding hitch system which enables the connection of a variety of tractor implements, said box scraper assembly including
a frame having two spaced opposing end sides, and a back side extending between the end sides,
a tool attachment having at least one arm, said arm having a first end and a second end opposite the first end,
a hydraulic lift having a hydraulic ram, wherein one end of the hydraulic lift is attached to the frame, and the hydraulic ram opposite the one end is pivotally attached to the first end of the arm of the tool attachment,
a horizontal bar attached to the second end of the arm,
at least one tool member attached to a side of the horizontal bar,
a rake member positioned forward of said back side between the end sides of the box scraper, and
pivot means attached to the rake member for pivoting the rake member;
wherein the hitch system including
first and second upwardly extending arms having upper and lower ends, wherein the lower ends are attached to the support member of the box scraper, and the upper ends upwardly extend from the support member forming an upper bracket for connecting with the tractor's three-point hitch,
a first scraper bracket formed of the lower end of the first extending arm and a first plate attached to the support member parallel with the lower end of the first extending arm, and a second scraper bracket formed of the lower end of the second extending arm and a second plate attached to the support member parallel with the lower end of the second extending arm,
a first attachment means for releasably attaching the tractor's three-point hitch to the first and second scraper brackets,
a first extension member that downwardly depends from the first plate, and a second extension member that downwardly extends from the second plate, wherein the extension members include an extension aperture, and
a stop block attached at an angle to the outer surface of the extension members;
wherein the tractor implement including
a horizontal brace member,
first and second implement brackets attached to the brace member, said first and second implement brackets each formed of an inner plate and an outer plate, said inner and outer plates of the first and second implement brackets having aligned bracket apertures,
a first guide plate attached at an angle to an upper end of the inner plate of the first implement bracket, and a second guide plate attached at an angle to an upper end of the inner plate of the second implement bracket,
wherein said first and second implement brackets sized to releasably receive the first and second extension members of the box scraper,
a second attachment means for releasably attaching the first and second extension members of the box scraper to the first and second implement brackets of the tractor implement;
said method comprising the steps of:
mounting the box scraper to a three-point hitch at the rear of a tractor,
positioning the tractor implement on the ground,
raising the three-point hitch so that the box scraper is elevated a distance above the ground which is greater than the height of the first and second implement brackets of the tractor implement,
positioning the box scraper above the tractor implement so that the first and second extension members are directly above the first and second implement brackets,
lowering the box scraper so that the first extension member is received within the first implement bracket and the second extension member is received within the second implement bracket,
securing the extension members to the implement brackets with connecting pins.
